(19) United States
(12) Patent Application Publication
(10) Pub. No.: US 2018/0220629 A1
(43) Pub. Date: Aug. 9, 2018

(54) KAYAK FISHING STRINGER SYSTEM AND METHOD

(71) Applicant: Andrew D. Seal, Petal, MS (US)

(72) Inventor: Andrew D. Seal, Petal, MS (US)

(21) Appl. No.: 15/890,194

(22) Filed: Feb. 6, 2018

Related U.S. Application Data
(60) Provisional application No. 62/456,473, filed on Feb. 8, 2017.

(51) Int. Cl. A01K 65/00

(52) U.S. Cl. CPC A01K 65/00; B63B 2035/715

(57) ABSTRACT

A kayak fishing stringer system includes a spring-lock handle configured to retain a plurality of leashes to a watercraft. In the preferred embodiment the spring-lock handle that may be a carabiner clip is configured to retain the plurality of leashes comprising cables/rods having a first and a second loop to the watercraft by the spring-lock handle via the first loop and the second loop coupled to the double eye swiveled coupling coupled to the fish retaining safety hook. The system may be structured and arranged to provide a fishing stringer useful for culling and carrying fish caught when using a shallow water vessel.

### CROSS-REFERENCE TO RELATED APPLICATION(S)

The present application is related to and claims priority to U.S. Provisional Patent Application No. 62/456,473 filed Feb. 8, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing, trapping, and vermin destroying of existing art and more specifically relates to a kayak fishing stringer system.

### RELATED ART

Many people fish for food and/or sport. Fishing is the activity of trying to catch fish. Fish are normally caught in the wild. Techniques for catching fish include hand gathering, spearing, netting, angling and trapping. Fishing may also include catching aquatic animals other than fish, such as crustaceans and the like. Fish that are caught are typically kept in the water as long as possible to maintain freshness. Fishermen may use stringers in order to keep fish secure and alive before exiting the water. Most stringers are long and can get hung on structures underneath the water surface. These stringers typically have no handle forcing the owner to wrap the excess line around their hand this can be very uncomfortable with multiple fish on the line. A suitable solution is desired.

U.S. Pub. No. 2007/0215656 to David Reynolds relates to a fish stringer system. The described a fish stringer system includes multiple stringers of multiple lengths. Each stringer has an outer diameter with a reduced diameter portion. Each snap assembly includes a slider that includes a gap for receiving the reduced diameter portion of the stringer, wherein the slider has an inside dimension that allows the slider to slide over the outer diameter of the stringer. Each snap assembly includes a swivel coupled to the slider, and a snap coupled to the swivel. The sliders may be different colors, and the snaps may be different sizes. The stringer system provides a way to easily put fish on a stringer regardless of where the fisherman is located.

### SUMMARY OF THE INVENTION

In view of the foregoing disadvantages inherent in the known fishing, trapping, and vermin destroying art, the present disclosure provides a novel kayak fishing stringer system. The general purpose of the present disclosure, which will be described subsequently in greater detail, is to provide an efficient and effective kayak fishing stringer system.

A kayak fishing stringer system is disclosed herein. The kayak fishing stringer system includes a spring-lock handle configured to retain a plurality of leashes to a watercraft, the plurality of leashes each including a first loop configured to be removably couplable to the spring-lock handle at a first end, a second loop at a second end of each of the plurality of leashes configured to couple to a double eye swiveled coupling and a fish retaining safety hook.

In the preferred embodiment the spring-lock handle that may be a carabiner clip is configured to retain the plurality of leashes comprising cables/rods having a first and a second loop to the watercraft by the spring-lock handle via the first loop and the second loop coupled to the double eye swiveled coupling coupled to the fish retaining safety hook. The system may be structured and arranged to provide a fishing stringer useful for culling and carrying fish caught when using a shallow water vessel. The present invention provides users with a spider stringer for fisherman designed to keep fish attached to the kayak or another suitable attachment point. This eliminates the need to use long stringers which usually cause the stringer and fish to be hung on the structure underneath the kayak. It keeps fish just beneath the surface until the fisherman exits the water. It includes a large carabineer (or the like) that hooks onto a suitable point of the kayak or a belt loop for a secure connection. The present invention features up to 10 nylon-coated cables for attaching fish.

According to another embodiment, a method of using a kayak fishing stringer system is also disclosed herein. The method includes the steps of: providing a spring-lock handle configured to retain a plurality of leashes to a watercraft, attaching the spring-lock handle to a watercraft, opening the fish retaining safety hook, affixing the fish caught to the fish retaining safety hook, closing the fish retaining safety hook, culling the fish caught and carrying the fish caught.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a kayak fishing stringer system and method, constructed and operative according to the teachings of the present disclosure.

FIG. 1 is a top view of the kayak fishing stringer system during an ‘in-use’ condition, according to an embodiment of the disclosure.

FIG. 2 is a side view of the kayak fishing stringer system of FIG. 1, according to an embodiment of the present disclosure.

FIG. 3 is a side view of the kayak fishing stringer system of FIG. 1, according to an embodiment of the present disclosure.

FIG. 4 is a perspective view of the kayak fishing stringer system of FIG. 1, according to an embodiment of the present disclosure.

FIG. 5 is a flow diagram illustrating a method of use for the kayak fishing stringer system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to fishing, trapping, and vermin destroying and more particularly to a kayak fishing stringer system and method as used to improve the efficiency of fishing and keeping fish fresh.

Generally, the kayak fishing stringer system is mostly designed for kayak fishermen. Most stringers are too long for use in kayaks while floating rivers and creeks. The stringer and fish get hung on structure underneath the kayak and can cause you to lose fish or the stringer and can be hazardous if the current is swift. This stringer is much shorter and keeps all your fish just beneath the surface. It has a large carabiner that hooks to a suitable point on the kayak. There are nylon coated cables/rods approximately 16 inches long that are connected to the carabiner. On the other end of each cable/rod is a snap or clip that attaches to the fish's mouth.

As designed, the device keeps the fish right under the surface so that underwater structure that it may become tangled in can be avoided. With this stringer the user doesn't have to pick up all the fish to put another fish on; the user just picks up an empty cable/rod and hooks it on. The other fish stay in the water undisturbed which increases their survival rate which is very important for tournament fishermen. The carabiner also works as a perfect handle to carry the stringer when it's full of fish and it's short so the user doesn't have to wrap all the extra line around his/her hand like is the case with other stringers. The carabiner can be attached easily to any point on the kayak or to the user's belt loop if he/she is wade fishing. The individual cables/rods can also be color coded to keep up with different size fish for culling.

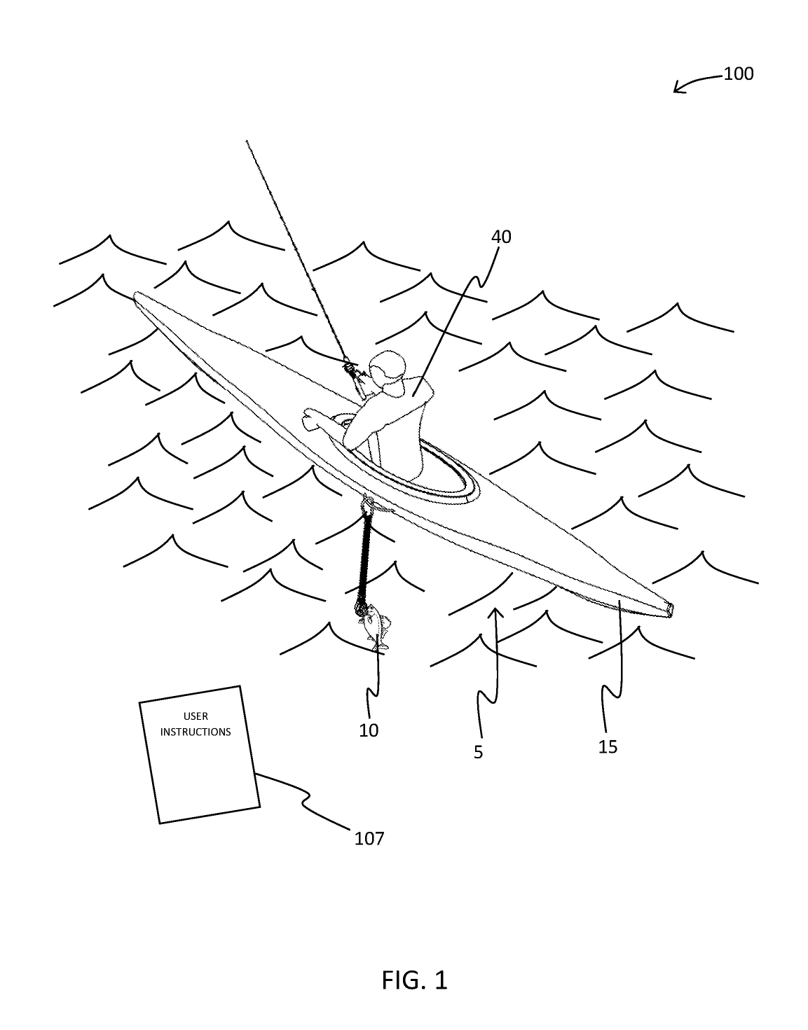

Referring now more specifically to the drawings by numerals of reference, there is shown in FIGS. 1-4, various views of a kayak fishing stringer system 100.

FIG. 1 shows a kayak fishing stringer system 100 during an ‘in-use’ condition 50, according to an embodiment of the present disclosure. Here, the kayak fishing stringer system 100 may be beneficial for use by a user 40 to provide a kayak fishing stringer system 100 that may be mostly designed for kayak 15 fishermen to prevent the stringer and fish 10 from getting ‘hung’ on structure underneath the kayak 15 that can cause the fisherman to lose fish 10 or the stringer and can be hazardous if the current is swift.

As illustrated, the kayak fishing stringer system 100 may include a spring-lock handle 110 configured to be removably couplable to a suitable point of a watercraft 5 and retain a plurality of leashes 120 to the watercraft 5. A plurality of leashes 120, each including a first loop 122 that may be configured to be removably couplable to the spring-lock handle 110, at the first end. A second loop 124, at a second end of each of the plurality of leashes 120, may be configured to be removably couplable to a double eye swiveled coupling 126. Further, a fish retaining safety hook 128 may also be removably couplable to the double eye swiveled coupling 126. Therefore, the spring-lock handle 110 may be configured to retain the plurality of leashes 120 to the watercraft 5 by the spring-lock handle 110 via the first loop 122 and the second loop 124 being coupled to the double eye swiveled coupling 126 coupled to the fish retaining safety hook 128. The system may be structured and arranged to provide a fishing stringer useful for culling and carrying fish 10 caught when using a shallow water vessel such as a kayak 15. The kayak fishing stringer system 100 may further provide a precautionary measure against hazards caused by ordinary stringers that may become tangled underwater structure.

According to one embodiment, the kayak fishing stringer system 100 may be arranged as a kit 105. In particular, the kayak fishing stringer system 100 may further include a set of instructions 107. The instructions 107 may detail functional relationships in relation to the structure of the kayak fishing stringer system 100 such that the kayak fishing stringer system 100 can be used, maintained, or the like, in a preferred manner.

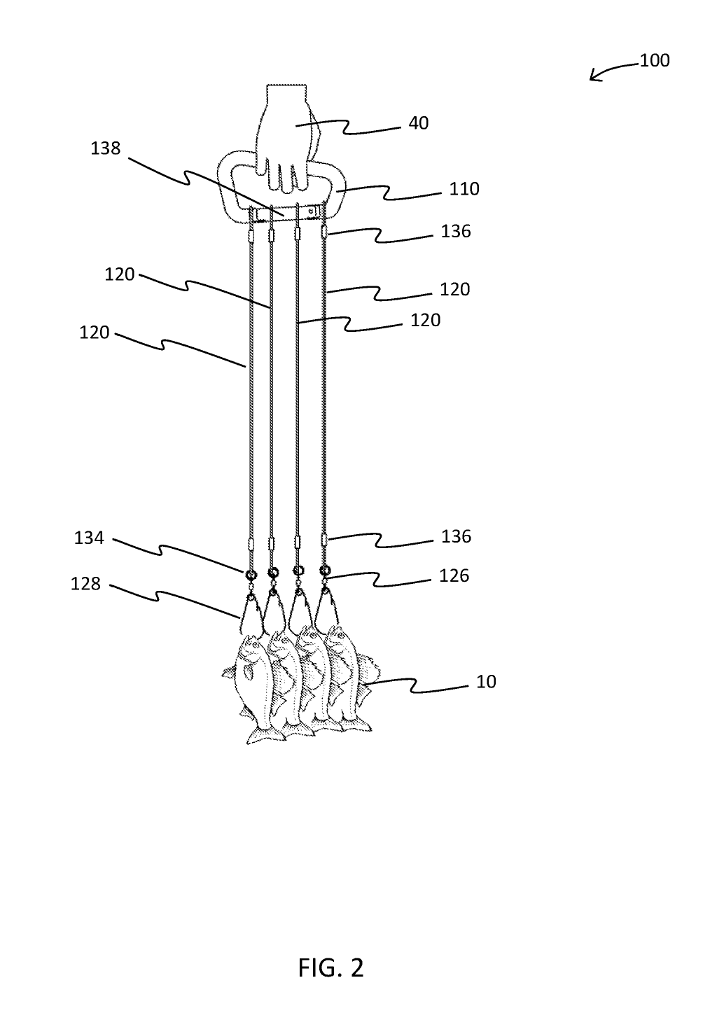

FIG. 2 shows the kayak fishing stringer system 100 of FIG. 1, according to an embodiment of the present disclosure. As above, the kayak fishing stringer system 100 may include a spring-lock handle 110 configured to retain a plurality of leashes 120 to a watercraft 5. Each of the plurality of leashes 120 including a first loop 122 configured to be removably couplable to the spring-lock handle 110 at a first end. A second loop 124 at a second end configured to couple to a double eye swiveled coupling 126 and a fish retaining safety hook 128.

According to an embodiment of the present disclosure the spring-lock handle 110 may be a carabiner clip or the like preferably made of a corrosion resistant material configured to retain the plurality of leashes 120 to the watercraft 5 by coupling the spring-lock handle 110 to a suitable point on the watercraft 5 and the first loop 122 at a first end of each leash. The second loop 124 at a second end coupled to the double eye swiveled coupling 126 coupled to the fish retaining safety hook 128 is configured to provide a fishing stringer useful for culling and carrying fish 10 caught when using a shallow water vessel, the shallow water vessel may comprise a kayak 15.

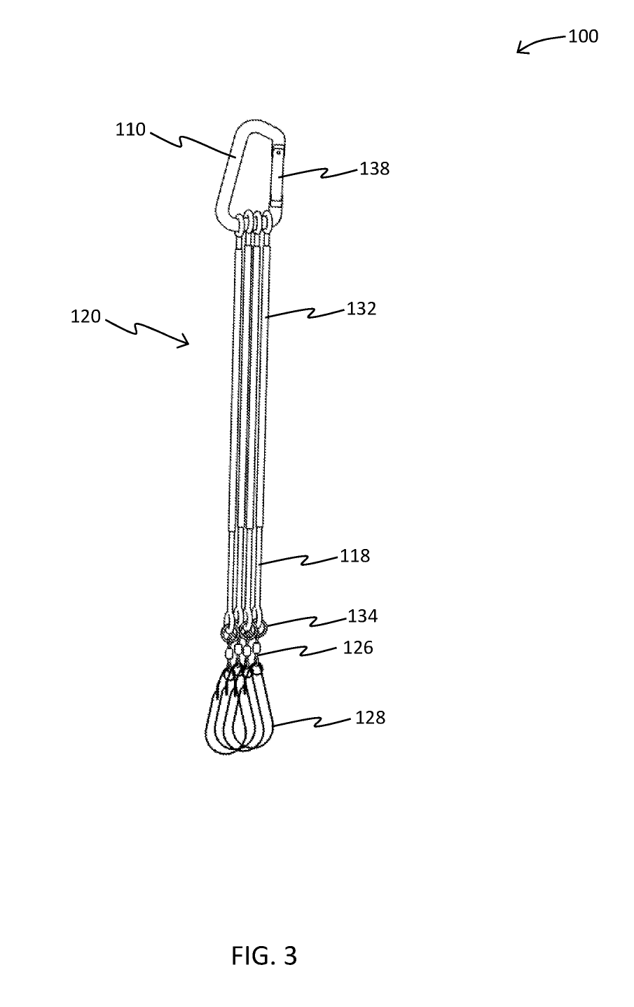

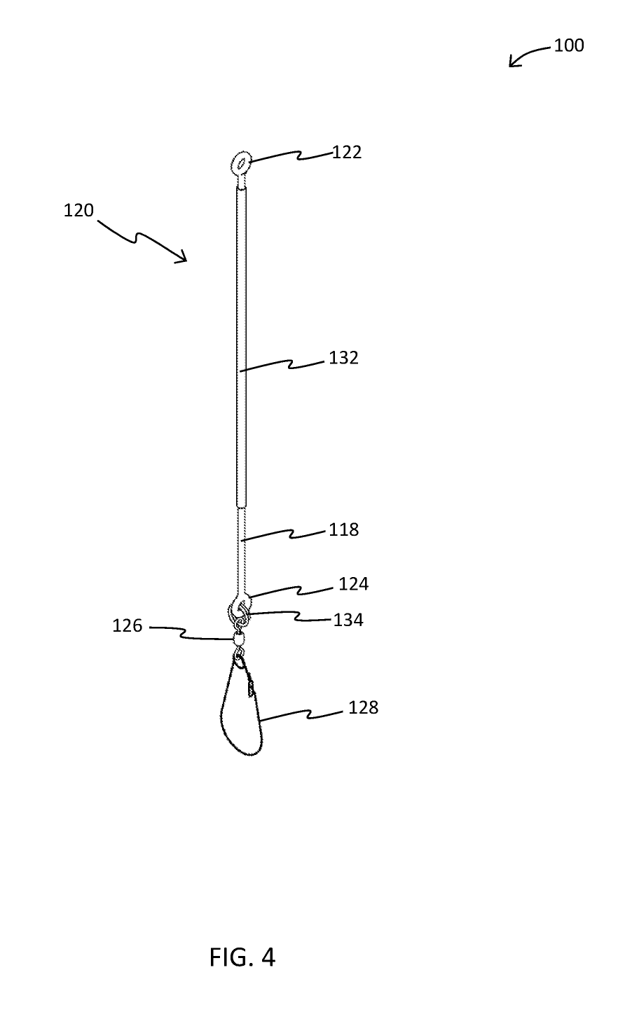

The spring-lock handle 110 may be a carabiner clip made of a corrosion resistant material and each of the plurality of leashes 120 may be about 16 inches long. Further, each of the plurality of leashes 120 may comprise a rod 118 as shown in FIGS. 3 and 4. Although in other embodiment's wire rope leashes 120 may be envisioned and may also include a nylon coating 132. According to an embodiment of the present disclosure, the first loop 122 and the second loop 124 are integral to the rod 118. In other embodiments comprising wire rope leashes 120, the first loop 122 and the second loop 124 may be held in place using a cable compression binder 136. The wire rope leashes 120 may be made of stainless steel. Additionally, also shown in FIGS. 3 and 4 at least a portion of each of the pluralities of leashes 120 may include a nylon coating 132 that is color coated to aid in culling of the fish 10 by size and alternately species.

The double eye swiveled coupling 126 may be removably couplable to the second loop 124 via a small key-ring-coupler 134. The small key-ring-couplers 134 may also be a corrosion resistant material. Further the fish retaining safety hook 128 may be removably couplable to the double eye swiveled coupling 126 via a small key-ring-coupler 134 as well. The fish retaining safety hook 128 is a biasing spring hook loop and catch mechanism. Further the fish retaining safety hook 128 may be a corrosion resistant metal.

Referring now to FIG. 3, a side view of the kayak fishing stringer system 100 of FIG. 1, according to an embodiment of the present disclosure. As illustrated, the spring-lock handle 110 may be a carabiner clip made of a corrosion resistant material and each of the plurality of leashes 120 may be about 16 inches long. As shown each of the plurality of leashes 120 may comprise a rod 118 also made of a corrosion resistant material having an integral loop at a first end and at a second end. As shown here in FIG. 3 the integral loop at the first end is removably couplable to the spring-lock handle 110. Provided on the spring-lock handle 110 is a spring-lock gate 138. The spring-lock gate 138 is pivotable on an axle and the spring-lock gate 138 is held in a closed position by an internal biasing spring. The spring-lock gate 138 further provides an opening useful for removably coupling the spring-lock handle 110 to a suitable point of a watercraft 5.

Still referring to FIG. 3 as illustrated, the plurality of leashes 120, each preferably comprise a rod 118; each rod 118 including at least a portion of the rod 118 having nylon coating 132. In an embodiment of the present disclosure the nylon coating 132 may be color coated useful for aiding the culling of caught fish 10 by size and alternately species. Furthermore, it should be noted that the kayak fishing stringer system 100 is configured to be removably couplable to a suitable point on the outer body garment of a user 40 when wade fishing and/or suitable shoreline structure if a watercraft 5 is not being used.

FIG. 4 is a perspective view of the kayak fishing stringer system 100 of FIG. 1, according to an embodiment of the present disclosure. As illustrated, the rod 118 including an integral first loop 122 configured to be removably couplable to the spring-lock handle 110 at a first end. An integral second loop 124 at a second end is configured to be removably couplable to a double eye swiveled coupling 126 and a fish retaining safety hook 128. And as shown at least a portion of the rod 118 may include a coating 132. The coating 132 may be nylon or rubberized material, although an embodiment may be painted or at least a portion thereof may be painted. The coating 132 may be utilized to provide a means of not only corrosion protection but also an aid for culling of fish 10 by size and alternately species as mentioned above.

Continuing with FIG. 4, an integral second loop 124 at a second end is configured to be removably couplable to a double eye swiveled coupling 126. In an embodiment of the present disclosure the double eye swiveled coupling 126 may be affixed via a small key-ring-coupler 134 also known in the art as a split-ring connector as illustrated. Other embodiments may not include double eye swiveled coupling 126 or a small key-ring-coupler 134. A fish retaining safety hook 128 may be permanently coupled to the second loop 124 at a second end. Additionally, the fish retaining safety hook 128 is a biasing spring hook loop and catch mechanism commonly found in the art of fishing stringers. Upon reading this specification, it should be appreciated that, under appropriate circumstances, considering such issues as user preferences, design preference, structural requirements, marketing preferences, cost, available materials, technological advances, etc., other leash arrangements such as, for example, fiber rope, wire rope 130, rod 118 or combination thereof, etc., may be sufficient.

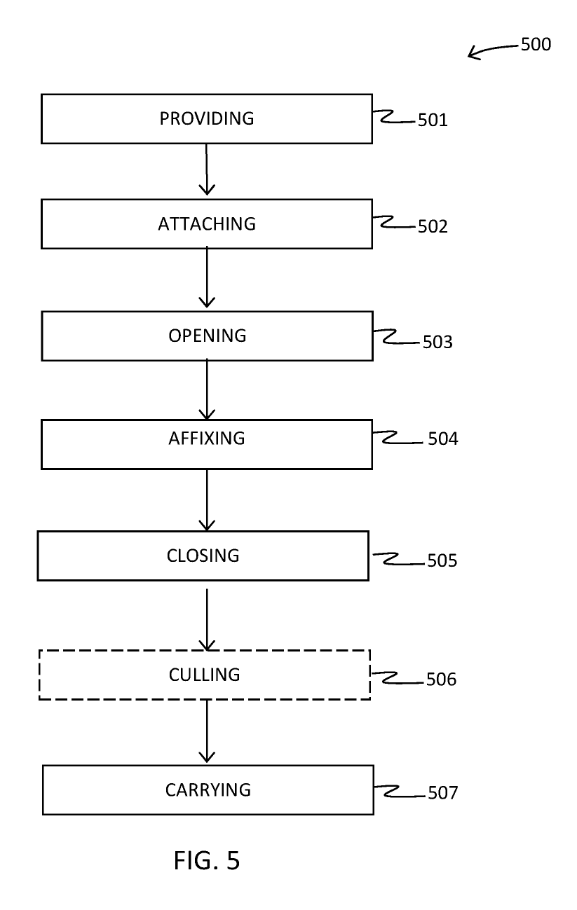

Referring now to FIG. 5, a flow diagram illustrating a method for kayak fishing stringer system 500, according to an embodiment of the present disclosure. In particular, the method for kayak fishing stringer system 500 may include one or more components or features of the kayak fishing stringer system 100 as described above. As illustrated, the method for kayak fishing stringer system 500 may include the steps of: step one 501, providing a spring-lock handle configured to retain a plurality of leashes to a watercraft, each of the plurality of leashes including a first loop configured to be removably couplable to the spring-lock handle at a first end, and a second loop at a second end configured to couple to a double eye swiveled coupling and a fish retaining safety hook; step two 502, attaching the spring-lock handle configured to retain each of the plurality of leashes to a suitable point on the watercraft; step three 503, opening the fish retaining safety hook biasing spring hook loop and catch mechanism; step four 504, affixing the fish caught to the fish retaining safety hook biasing spring hook loop and catch mechanism; step five 505, closing the fish retaining safety hook biasing spring hook loop and catch mechanism; step 506, culling the fish caught; and step 507, carrying the fish caught from the vessel to a desired location.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the kayak fishing stringer system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A kayak fishing stringer system, the system comprising:
a spring-lock handle configured to retain a plurality of leashes to a watercraft;
said plurality of leashes each including a first loop configured to be removably couplable to said spring-lock handle at a first end; and
a second loop at a second end of each of said plurality of leashes configured to couple to a double eye swiveled coupling;
a fish retaining safety hook; and
wherein said spring-lock handle is configured to retain said plurality of leashes to said watercraft by said spring-lock handle first loop and said second loop coupled to said double eye swiveled coupling coupled to said fish retaining safety hook structured and arranged to provide a fishing stringer useful for culling and carrying fish caught when using a shallow water vessel.

2. The system of claim 1, wherein the spring-lock handle is a carabiner clip.

3. The system of claim 2, wherein the carabiner clip is made of a corrosion resistant material.

4. The system of claim 1, wherein each of the plurality of leashes are approximately 16 inches long.

5. The system of claim 1, wherein the plurality of leashes comprises wire rope.

6. The system of claim 5, wherein the wire rope includes a nylon coating.

7. The system of claim 5, wherein the wire rope is stainless steel.

8. The system of claim 1, wherein each of the plurality of leashes comprise a rod.

9. The system of claim 1, wherein each of the pluralities of leashes are color coated to aid in culling of said fish by size and alternately species.

10. The system of claim 1, wherein the double eye swiveled coupling is removably couplable to said second loop via a small key-ring-coupler

11. The system of claim 10, wherein the small key-ring couplers comprise a corrosion resistant metal.

12. The system of claim 1, wherein the fish retaining safety hook is couplable to said double eye swiveled coupling via a small key-ring-coupler.

13. The system of claim 1, wherein the fish retaining safety hook is a biasing spring hook loop and catch mechanism.

14. The system of claim 1, wherein the fish retaining safety hook comprises a corrosion resistant metal.

15. The system of claim 1, wherein said first loop and said second loop are held in place using a cable compression binder.

16. The system of claim 8, wherein the said first loop and said second loop are integral to said rod.

17. A kayak fishing stringer system, the system comprising:
a spring-lock handle configured to retain a plurality of leashes to a watercraft;
each of said plurality of leashes including a first loop configured to be removably couplable to said spring-lock handle at a first end; and
a second loop at a second end configured to couple to a double eye swiveled coupling;
a fish retaining safety hook; and
wherein said spring-lock handle configured to retain said plurality of leashes to said watercraft by said spring-lock handle first loop and said second loop coupled to said double eye swiveled coupling coupled to said fish retaining safety hook is configured to provide a fishing stringer useful for culling and carrying fish caught when using a shallow water vessel, said shallow water vessel comprising a kayak,
wherein the spring-lock handle is a carabiner clip;
wherein the carabiner clip is made of a corrosion resistant material;
wherein each of the plurality of leashes are about 16 inches long;
wherein each of the plurality of leashes comprise a rod;
wherein each of the pluralities of leashes are color coated to aid in culling of said fish by size and alternately species.

18. The kayak fishing stringer system of claim 17, further comprising set of instructions; and
wherein the system is arranged as a kit.

19. A method of use for a kayak fishing stringer system, the method comprising the steps of:
providing a spring-lock handle configured to retain a plurality of leashes to a watercraft; each of said plurality of leashes including a first loop configured to be removably couplable to said spring-lock handle at a first end; and a second loop at a second end configured to couple to a double eye swiveled coupling and a fish retaining safety hook;
attaching said spring-lock handle configured to retain each of said plurality of leashes to suitable point on said watercraft;
opening said fish retaining safety hook biasing spring hook loop and catch mechanism;
affixing said fish caught to said fish retaining safety hook biasing spring hook loop and catch mechanism;
closing said fish retaining safety hook biasing spring hook loop and catch mechanism; and
culling said fish caught.

20. The method of claim 19, further comprising the steps of;
carrying said fish caught from said vessel to a desired location.
